(19) United States
(12) Patent Application Publication
(10) Pub. No.: US 2024/0254580 A1
(43) Pub. Date: Aug. 1, 2024

(54) Forced air cooling for cooling long steel products

(71) Applicant: SMS group GmbH, Düsseldorf (DE)

(72) Inventors: Ran YANG, Aachen (DE); Jens OESTRICH, Mönchengladbach (DE); Frank STEDEN, Lennestadt (DE); Dirk WINTERFELDT, Koschenbroich (DE); Olaf KOCH, Mönchengladbach (DE); Hans-Peter DRÜGH, Mechernich (DE)

(73) Assignee: SMS group GmbH, Düsseldorf (DE)

(21) Appl. No.: 18/290,360

(22) PCT Filed: Apr. 22, 2022
(86) PCT No.: PCT/EP2022/060726

§ 371 Date: Nov. 13, 2023

(30) Foreign Application Priority Data
May 31, 2021 (DE) 10 2021 205 520.6
Nov. 8, 2021 (DE) 10 2021 212 523.9

(51) Int. Cl. C21D 1/673; B21B 45/02; C21D 1/613; C21D 9/04; C21D 11/00

(52) U.S. Cl. CPC C21D 1/673; C21D 1/613; C21D 9/04; C21D 11/005; B21B 2045/0212

(57) ABSTRACT

The present application relates to a heat treatment unit, in particular a cooling hood, including a chamber with an inlet opening through which a gaseous cooling medium can be fed to the chamber, and a slot-shaped outlet opening through which the gaseous cooling medium can be discharged faster. The chamber includes a central chamber segment and a first and a second outer chamber segment extending from the central chamber segment, and both outer chamber segments have a cross-section tapering proportionally towards their distal ends, and a device for the heat treatment of hot-rolled long steel products.

### CROSS-REFERENCE TO RELATED APPLICATION

This application is a national stage application, filed under 35 U.S.C. § 371, of International Patent Application PCT/EP2022/060726, filed on Apr. 22, 2022, which claims the benefit of German Patent Applications DE 10 2021 205 520.6, filed on May 31, 2021, and DE 10 2021 212 523.9, filed on Nov. 8, 2021.

### TECHNICAL FIELD

The present disclosure relates to a heat treatment unit, in particular a cooling hood, a device along with a method for the heat treatment of hot-rolled long steel products.

### BACKGROUND

In order to adjust the mechanical properties, such as in particular the yield strength, tensile strength or hardness, of hot-rolled long steel products, these are cooled in a targeted manner by means of cooling devices during and/or after a hot rolling operation. In the prior art, water or a water-air mixture is generally used as the cooling medium for this purpose, as disclosed, for example, in EP 1 412 543 B1. However, such cooling media lead to the formation of the so-called “Leidenfrost phenomenon,” which leads to deviations in the cooling rate over the entire length of the long steel product and thus to the formation of inhomogeneous microstructures.

U.S. Pat. No. 4,913,747 also discloses a method and a device for hardening a rail head by means of air or nitrogen. Thereby, the coolant is fed via a line system to a collector, which comprises a plurality of nozzles. The disadvantage of such embodiment is the complex construction of the cooling apparatus with its many nozzles and holes.

### SUMMARY

It is the object of the present disclosure to provide an improved device compared to the prior art along with an improved method compared to the prior art for the heat treatment of hot-rolled long steel products.

The object is achieved by a heat treatment unit as disclosed herein, by a device as disclosed herein and by a method as disclosed herein.

In a first aspect, the disclosure relates to a heat treatment unit, in particular a cooling hood, preferably for use in a device for the heat treatment of hot-rolled long steel products, comprising a chamber having an inlet opening through which a gaseous cooling medium can be fed to the chamber and a slot-shaped outlet opening through which the gaseous cooling medium can be discharged faster, wherein the chamber comprises a central chamber segment along with a first and second outer chamber segment extending from the central chamber segment and both outer chamber segments have a cross-section that tapers proportionally towards their distal ends.

The design of the heat treatment unit, in particular the proportional reduction of the flow cross-section over the length of the respective outer chamber segment, enables a uniform flow of the gaseous cooling medium, such as air or nitrogen, at the slot-shaped outlet opening over the entire length of the chamber. By using such heat treatment units, the hot-rolled long steel products can be cooled homogeneously and uniformly, such that their mechanical properties are improved. The fact that the outlet opening is slot-shaped also means that less maintenance is required in contrast with conventional conical or flat spray nozzles.

Further advantageous embodiments of the invention are indicated in the dependent formulated claims. The features listed individually in the dependent formulated claims can be combined with one another in a technologically useful manner and may define further embodiments of the invention. In addition, the features indicated in the claims are further specified and explained in the description, wherein further preferred embodiments of the invention are shown.

In the context of the present application, the term “cross-section” is understood to refer to a cross-sectional area.

In the context of the present application, the term “long steel product” is understood to refer to a metallic product that can have a length of up to 200 m, such as rails, in particular railroad rails, H-shaped beams, U-shaped sections, angles, etc.

The central chamber segment advantageously has a constant cross-section along a longitudinal axis of the chamber, and in this connection it is preferably provided that the inlet opening is arranged in the central chamber segment. The inlet opening can have a smaller inlet cross-section compared to the cross-section of the center chamber segment. The larger cross-section in the central chamber segment allows the cooling medium flowing through the inlet opening into the chamber to calm down initially before continuing to flow in the direction of the slot-shaped outlet opening. The larger inlet cross-section compared to the slot-shaped outlet opening also keeps the flow velocity of the cooling medium very low at the inlet of the chamber and high at the outlet. The change in cross-section and the resulting change in flow velocity significantly reduce turbulence, such that it is ensured that the cooling medium flows out very evenly along the entire length of the slot-shaped outlet opening. The factor of velocity change between the inlet and the outlet of the chamber can preferably be 3 to 20. For example, the flow velocity at the inlet can be 10 to 50 m/s. Accordingly, the flow velocity of the cooling medium at the outlet can then be 3 to 20 times this, as a function of the selected cross-sectional ratios.

Advantageously, therefore, it is provided that the cross-sections arranged at the distal ends of the two outer chamber segments are smaller than the cross-section of the central chamber segment by at least a factor of 3, preferably by at least a factor of 4, even more preferably by at least a factor of 10.

To further increase the uniformity of the flow at the outlet, each of the chamber segments advantageously has a cross-sectional portion tapering conically in the direction of the slot-shaped outlet opening, which can be formed to be symmetrical or alternatively asymmetrical.

In principle, the inlet opening can be formed directly in the central chamber segment in the form of an opening. In a preferred embodiment, however, it is provided that the heat treatment unit comprises an inlet nozzle arranged in the inlet opening, which inlet nozzle is formed from a cup-shaped body and in each case has an opening aligned with each of the outer chamber segments. In this connection, it is preferred that each of the two openings has a cross-section corresponding to at least half the inlet cross-section. This also prevents the formation of turbulence within the chamber and thus has a beneficial effect on the flow properties. Thereby, the base of the cup-shaped inlet nozzle ensures, on the one hand, that the cooling medium flowing into the central chamber segment is deflected into the two outer chamber segments and thus cannot exit again directly via the slot-shaped outlet opening of the central chamber segment. On the other hand, the pressure above the slot-shaped outlet opening can be kept constant over the entire length of the chamber.

In order to obtain further flexibility in adjusting the ratio between inlet and outlet velocity, which can be achieved by adjusting the cross-sections as already explained, it is advantageously provided that the cross-section of the slot-shaped outlet opening is designed to be adjustable. Thus, the cooling rate for the hot-rolled long steel product can be continuously controlled by adjusting the cross-section of the slot-shaped exit opening.

Preferably, the slot-shaped outlet opening can be adjusted in the range of 0.5 to 50 mm, depending on the required cooling width.

In a further aspect, the present disclosure relates to a device for the heat treatment of hot-rolled long steel products, comprising a receiving device for receiving the hot-rolled long steel product and at least one heat treatment unit, through which the long steel product to be cooled can be acted upon by a gaseous cooling medium, in particular air or nitrogen.

In order to achieve this, for example, ambient air can be fed to the heat treatment unit as a cooling medium by means of a suitable blower device. Due to the cross-sectional constriction at the slot-shaped outlet opening, the cooling medium is accelerated through it in such a manner that the cooling medium acts upon the surface of the hot-rolled long steel product to be cooled at a high velocity, which can be 200 m/s, for example. Advantageously, therefore, it is provided that the device also comprises at least one blower device through which a gaseous cooling medium, such as air or nitrogen, can be fed to the heat treatment unit.

In addition, since the cooling rate on the surface of the hot-rolled long steel product can be determined by the flow velocity, a rotational speed-controlled blower device enables the cooling rate to be continuously adjusted, which can be 1 to 20 K/s, for example.

The at least one heat treatment unit is advantageously arranged in the device in such a manner that the slot-shaped outlet opening is positioned longitudinally parallel to the receiving device. In addition, it is further preferred that the distance between the slot-shaped outlet opening and the receiving device is adjustable, particularly preferably in such a manner that the distance between the outlet opening and the surface of the long steel product to be cooled amounts to 5 to 300 mm.

In a particularly advantageous embodiment, the device for heat treatment is formed to be modular, such that one or more heat treatment unit(s) can be arranged around a length segment of the long steel product and/or one or more heat treatment unit(s) can be arranged along a plurality of length segments or along the entire length of the long steel product.

The cooling intensity in each of the cooling modules can be adapted individually based on the detected temperature of the long steel product. In this manner, different temperature profiles over the entire length of the long steel product can be compensated for by targeted cooling. In order to carry out a corresponding temperature control, the device therefore advantageously comprises at least one temperature sensor through which the temperature of the long steel product can be detected, preferably during a heat treatment. Preferably, the temperature sensor is a pyrometer or thermal imaging camera. Other temperature sensors known to the person skilled in the art at the time of the application can also advantageously be used.

A further advantage of the modular design is its usability. Thus, by using a plurality of heat treatment units, different workpiece geometries can be cooled. Individual adaptation to the shape and necessary cooling capacity is possible by changing the number and redesigning the heat treatment unit or cooling hood, as the case may be.

In addition, electromagnetic sensors can be used to detect and monitor microstructural changes in the long steel product directly in the cooling process. Based on the determined microstructural patterns, the cooling rate can be adapted accordingly.

Depending on the embodiment of the heat treatment unit, in particular the cooling hood, or the device, the following further advantages also arise:
the cooling rate can be reliably and stably adjusted and offers the flexibility of adapting the necessary cooling rates for the heat treatment process for all common and also special material compositions;
the use of ambient air as a cooling medium is particularly resource-efficient compared to the liquid cooling media currently used, such as water, oil and/or water-air mixtures;
by using a blower device, such as a fan, a large volume of air can be transported at a low pressure, preferably up to 1320 mbar, such that no compressor is required.

In a further aspect, the present disclosure also relates to a method for the heat treatment of a hot-rolled long steel product, wherein the product is fed directly to a device for the heat treatment of hot-rolled long steel products following a hot rolling operation and heat treated. The gaseous cooling medium, in particular air or nitrogen, can be blown onto the hot-rolled long steel product at a velocity of at least 25 m/s, preferably at a velocity of at least 50 m/s, more preferably at a velocity of at least 100 m/s, even more preferably at a velocity of at least 125 m/s, and most preferably at a velocity of at least 150 m/s, depending on the desired cooling intensity.

Furthermore, the present disclosure relates to the use of the heat treatment unit or the device for forming a pearlitic, a ferritic, a bainitic and/or a martensitic microstructure in a hot-rolled long steel product.

The invention and the technical environment are explained in more detail below with reference to the figures. It should be noted that the invention is not intended to be limited by the exemplary embodiments shown. In particular, unless explicitly shown otherwise, it is also possible to extract partial aspects of the facts explained in the figures and combine them with other components and findings from the present description and/or figures. In particular, it should be noted that the figures and in particular the size relationships shown are only schematic. Identical reference signs designate identical objects, such that explanations from other figures may be used as a supplement if necessary.

### BRIEF DESCRIPTION OF THE DRAWINGS

FIG. 1 shows an embodiment of the heat treatment unit in a perspective view,

FIG. 2 shows the embodiment of the heat treatment unit shown in FIG. 1 in a lateral view,

FIG. 3 is a sectional view through the heat treatment unit shown in the previous figures,

FIG. 4 shows an embodiment of the inlet nozzle in a perspective view,

FIG. 5 shows an embodiment of the device for the heat treatment of long steel products,

FIG. 6 shows an embodiment of a control process,

FIG. 7 is an illustration of a rail head together with determined hardness values without heat treatment,

FIG. 8 is an illustration of a rail head together with determined hardness values with a heat treatment in accordance with the disclosure,

FIG. 9 shows results of cooling by means of a water-air mixture, and

FIG. 10 shows results of cooling according in accordance with the method in accordance with the disclosure.

### DETAILED DESCRIPTION

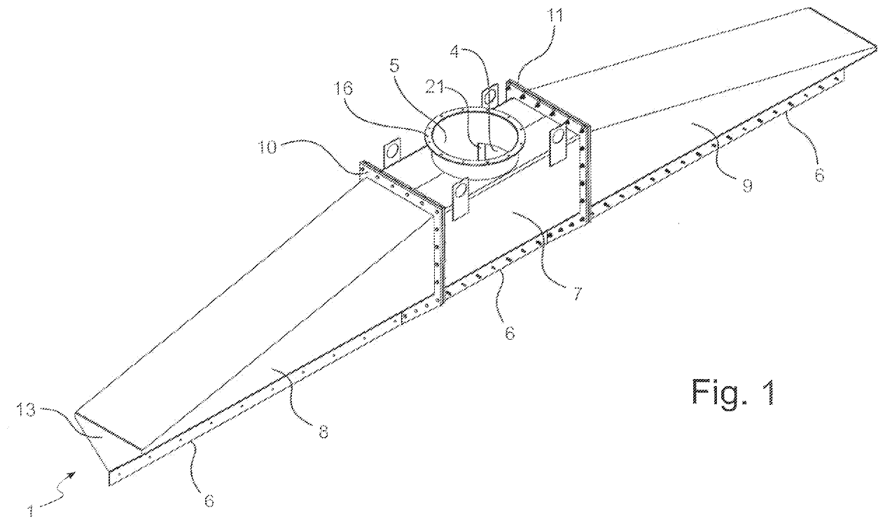

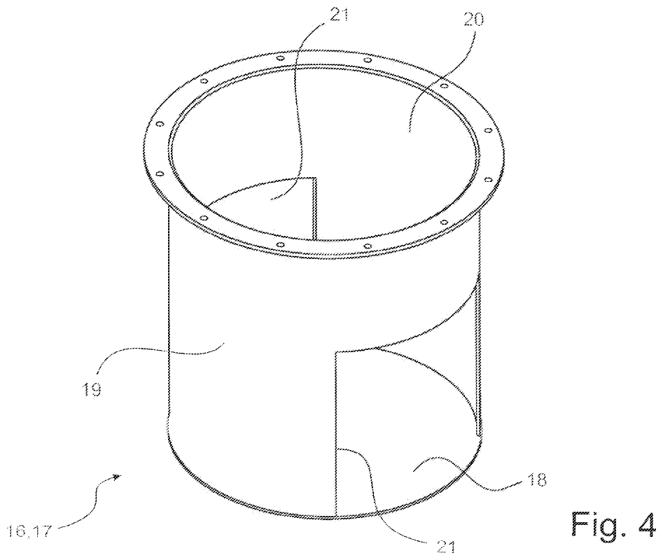

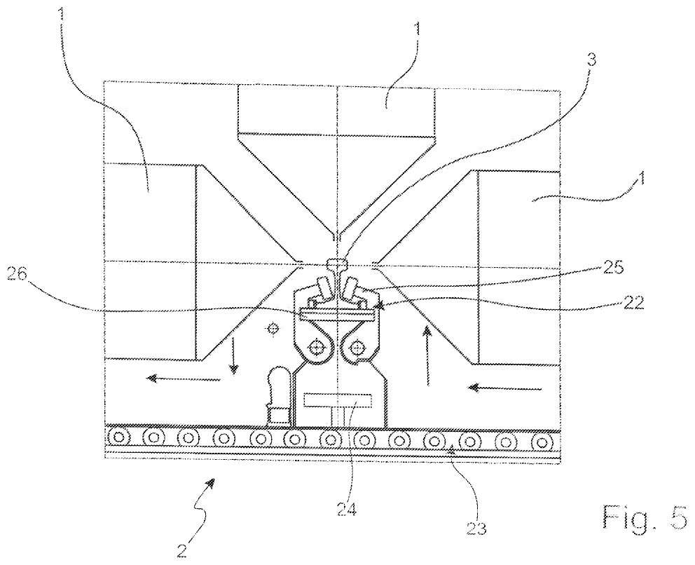

FIGS. 1 to 4 show an embodiment of the heat treatment unit 1, which is suitable and provided for a device 2 for the heat treatment of hot-rolled long steel products (see FIG. 5), such as rails 3.

The heat treatment unit 1, in particular a cooling hood, comprises a longitudinally extending chamber 4 with an inlet opening 5, through which a gaseous cooling medium, such as in particular ambient air, can be fed to the chamber 4, along with a slot-shaped outlet opening 6 extending longitudinally over the entire length of the chamber 4, through which the gaseous cooling medium can be discharged faster. The ambient air can preferably be drawn in by a blower device (not shown), such as a fan, and fed to the cooling hood 1 via a corresponding duct system (not shown). Thereby, the distance between the cooling hood 1 and the blower device should be as short as possible.

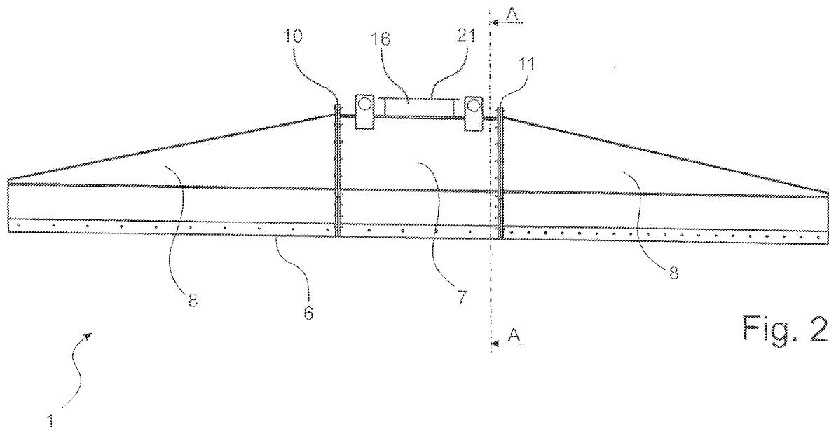

As can be seen from the representation in FIGS. 1 and 2, the cooling hood 1 is formed by a central chamber segment 7, which comprises the inlet opening 5, and first and second outer chamber segments 8, 9, each of which extends from the central chamber segment 7 and is connected thereto by flanged joints 10, 11.

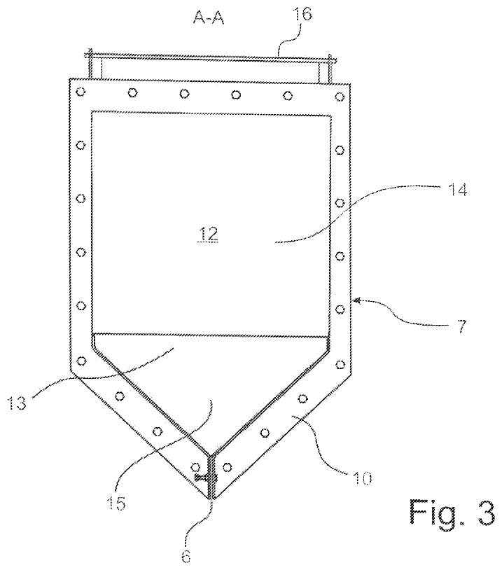

The central chamber segment 7 is formed in such a manner that it has a cross-section of the same size along the longitudinal axis of the chamber 4, which is illustrated here by the reference number 12 in the sectional representation shown in FIG. 3. In contrast, the two outer chamber segments 8, 9 have a cross-section that tapers proportionally toward their distal ends, which results in a value in cross-section 13 that is in the range of 2 to 6 times smaller at each of the distal ends of the outer chamber segments 8, 9. Thereby, it can be seen that each of the chamber segments 7, 8, 9 has, in addition to a square cross-sectional portion 14, a cross-sectional portion 15 tapering conically in the direction of the slot-shaped outlet opening 6.

Furthermore, in the present embodiment shown, the cooling hood 1 comprises an inlet nozzle 16 arranged in the inlet opening 5. In the present case, this is formed by a cup-shaped body 17, which comprises a base 18 and a cylindrical wall 19 and whose inlet nozzle opening 20 forms the inlet for the gaseous cooling medium. To allow the gaseous cooling medium to flow through the entire chamber 4, at least two openings 21 are provided in the cylindrical wall 19, each of which is aligned with the outer chamber segments 8, 9. In the present case, each of the two openings 21 has predominantly a cross-section equal to half the cross-section of the inlet nozzle opening 20.

The design ensures that the cooling medium, despite being fed centrally into the cooling hood 1, always has a constant air pressure at the outlet 6 over the entire chamber length or cooling hood length, as the case may be, such that a constant outflow velocity can be ensured over the cooling length.

FIG. 5 shows an embodiment of the device 2 for the heat treatment of long steel products 3, which comprises a receiving device 22 for receiving the hot-rolled long steel product 3 and, in the present case, three heat treatment units 1 through which the long steel product 3 to be cooled can be acted upon by the gaseous cooling medium and thus cooled in a targeted manner.

The device 1 further comprises a transport device 23 along with a lifting table 24, by means of which the long steel product shown in the form of a rail 3 can be lifted and fed to the receiving device 22. The receiving device 22 comprises a clamping device 25 by means of which the rail 3 can be clamped. The clamping device 25 can be formed in such a manner that the rail 3 can be moved longitudinally in the device 2 by means of roller table rollers 26.

In an alternative embodiment, the rail 3 can be fixed on a table in a stationary manner and the cooling system can be moved back and forth longitudinally over the rail 3 during cooling.

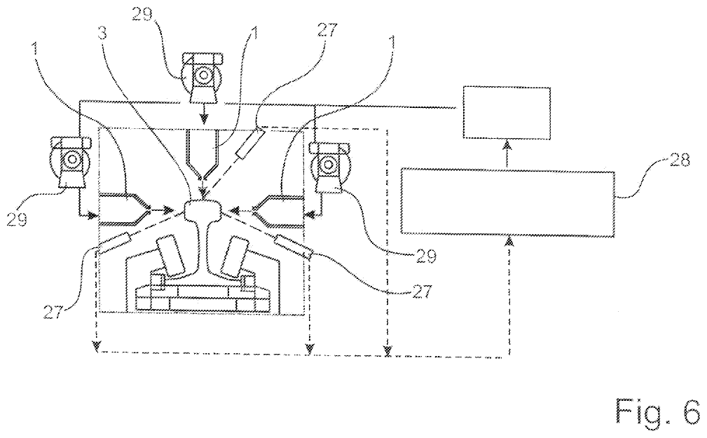

FIG. 6 shows an embodiment of a control process for the heat treatment of a long steel product or a rail 3, as the case may be. A temperature sensor 27, which is in the form of a pyrometer, is assigned to each of the three cooling hoods 1 and is positioned in such a manner that the temperatures from the TOP, SIDE-LEFT and SIDE-RIGHT rail head sides can be measured during the cooling process. The recorded temperatures T_TOPᵢₛₜ, T_SIDE-LEFTᵢₛₜ and T_SIDE-RIGHTᵢₛₜ are transmitted to a computer unit 28 by means of signals and compared with a target temperature (Tₛₒₗₗ) of a technological model. If one of the detected temperatures is greater than the target temperature, the cooling capacity can be individually adapted by increasing the rotational speed of a corresponding fan 29, such that the temperature difference is minimized.

### EXAMPLES

### Example 1

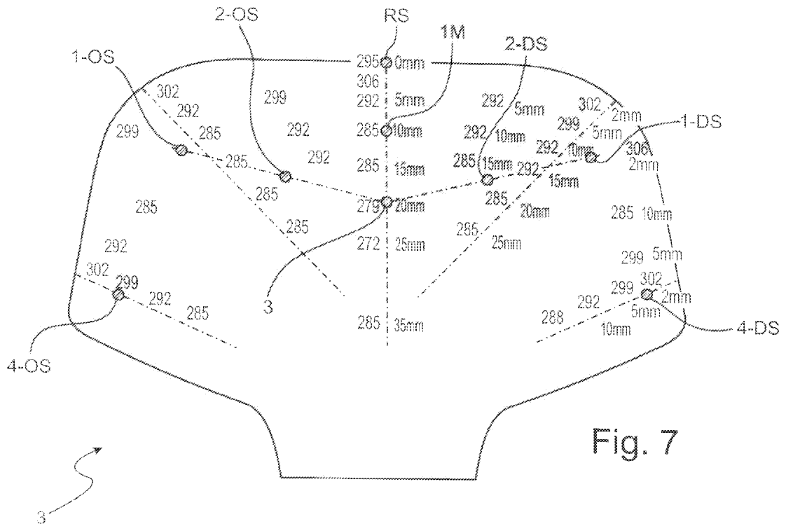

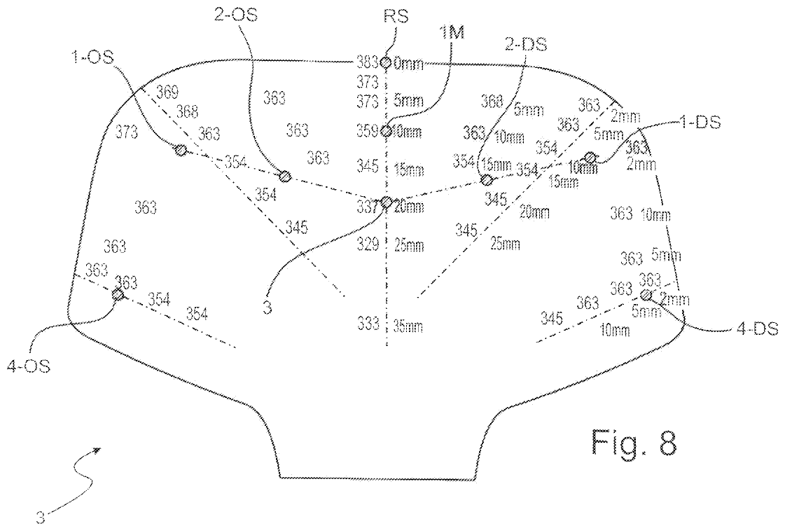

FIG. 7 shows hardness measurements in the cross-sectional area of a rail head that has not been subjected to heat treatment. FIG. 8 shows a rail that has been heat treated in accordance with the method in accordance with the disclosure. As can be seen from the values, the hardnesses in the rail head are on average up to 22% higher as a result of the cooling process in accordance with the disclosure.

### Example 2

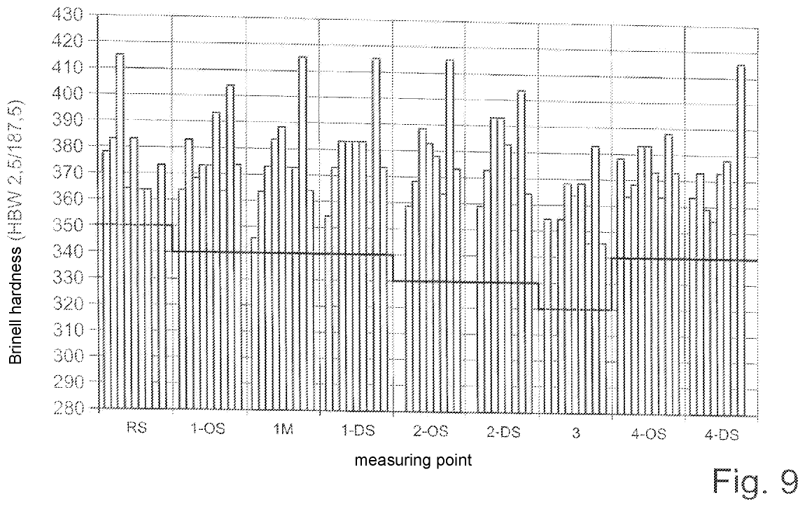

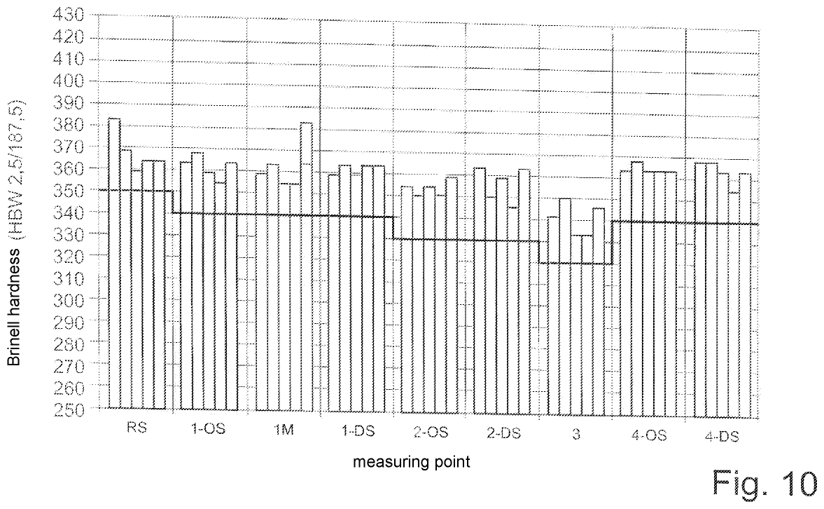

In each case, a plurality of hot-rolled rails were cooled at a temperature of 900° C. in order to adjust the desired microstructure. The rails were cooled on the one hand by means of a method known from the prior art using a water-air mixture (comparative example; FIG. 9) and on the other hand by means of the method in accordance with the disclosure using pure ambient air (FIG. 10). The cooling parameters were unchanged in each cooling method. After heat treatment, the Brinell hardnesses of the rails were determined at the defined points in the cross-section of the rail head in accordance with DIN13674.

As can be seen from the results in FIG. 9, the hardnesses vary greatly from rail to rail. In contrast, the hardnesses of the rails that have been cooled by means of the method in accordance with the disclosure are very stable (FIG. 10).

### LIST OF REFERENCE SIGNS

1 Heat treatment unit/cooling hood
2 Device
3 Long steel product/rail
4 Chamber
5 Inlet opening
6 Slot-shaped outlet/slot nozzle/outlet
7 Central chamber segment
8 First outer chamber segment
9 Second outer chamber segment
10 Flanged joint
11 Flanged joint
12 Cross-section of central chamber segment
13 Cross-section at the distal ends of the outer chamber segments
14 Cross-sectional portion
15 Cross-sectional portion
16 Inlet nozzle
17 Body
18 Base
19 Cylindrical wall
20 Inlet nozzle opening
21 Opening
22 Receiving device
23 Transport device
24 Lifting table
25 Clamping device
26 Roller table rollers
27 Temperature sensor/pyrometer
28 Computer unit
29 Blower device/fan

1.-16. (canceled)

17. A heat treatment unit (1), comprising
a longitudinally extending chamber (4), comprising:
an inlet opening (5) through which a gaseous cooling medium can be fed to the chamber (4);
a slot-shaped outlet opening (6) extending longitudinally along an entire length of the chamber (4) through which the gaseous cooling medium can be discharged;
a central chamber segment (7); and
a first and a second outer chamber segment (8, 9) extending from the central chamber segment (7), the first and the second outer chamber segment (8, 9) each having a cross-section tapering proportionally towards a distal end.

18. The heat treatment unit (1) according to claim 17,
wherein the heat treatment unit (1) is a cooling hood for cooling elongated steel products.

19. The heat treatment unit (1) according to claim 17,
wherein the central chamber segment (7) has a constant cross-section along a longitudinal axis of the chamber (4).

20. The heat treatment unit according to claim 17,
wherein the inlet opening (5) is arranged in the central chamber segment (7).

21. The heat treatment unit (1) according to claim 17,
wherein the first and the second outer chamber segment (8, 9) each have a distal end cross-section (13) that is smaller than a cross-section (12) of the central chamber segment (7) by at least a factor of 4.

22. The heat treatment unit (1) according to claim 17,
wherein the central chamber segment (7), the first, and the second outer chamber segment (8, 9) each have a cross-sectional portion (15) tapering conically towards the slot-shaped outlet opening (6).

23. The heat treatment unit (1) according to claim 17, further comprising:
an inlet nozzle (16) arranged in the inlet opening (5), comprising
a cup-shaped body (17) and
two openings (21), a first of the two openings (21) being aligned with the first outer chamber segment (8) and a second of the two openings (21) being aligned with the second outer chamber segment (9).

24. The heat treatment unit (1) according to claim 23,
wherein each of the two openings (21) has a cross-section corresponding to at least half an inlet cross-section of the cup-shaped body (17).

25. The heat treatment unit (1) according to claim 17,
wherein the cross-section of the slot-shaped outlet opening (6) is designed to be adjustable.

26. A device (2) for heat treating a hot-rolled long steel product (3), comprising:
a receiving device (22) for receiving the hot-rolled long steel product (3); and
at least one heat treatment unit (1) according to claim 17, through which the hot-rolled long steel product (3) to be cooled can be acted upon by the gaseous cooling medium.

27. The device (2) according to claim 26, further comprising
at least one temperature sensor (27) by which a temperature of the hot-rolled long steel product (3) can be detected during a heat treatment.

28. The device (2) according to claim 27,
wherein the temperature sensor (27) is a pyrometer.

29. A method for the heat treatment of a hot-rolled long steel product (3), comprising:
feeding the hot-rolled long steel product (3) directly to the device (2) according to claim 26 following a hot-rolling operation; and
heat-treating the hot-rolled long steel product (3) by the device (2).

30. The method according to claim 29,
wherein heat-treating the hot-rolled long steel product (3) comprises blowing air onto the hot-rolled long steel product (3) at a velocity of at least 150 m/s.

31. The method according to claim 29,
wherein the hot-rolled long steel product (3) is an H-beam, a U-section, an angle, or a rail.
